(19) United States
(12) Patent Application Publication
(10) Pub. No.: US 2024/0320957 A1
(43) Pub. Date: Sep. 26, 2024

(54) INFORMATION PROCESSING APPARATUS, INFORMATION PROCESSING METHOD, AND NON-TRANSITORY COMPUTER-READABLE MEDIUM

(71) Applicant: NEC Corporation, Minato-ku, Tokyo (JP)

(72) Inventor: Hiroshi Fukui, Tokyo (JP)

(73) Assignee: NEC Corporation, Minato-ku, Tokyo (JP)

(21) Appl. No.: 18/271,649

(22) PCT Filed: Jan. 13, 2022
(86) PCT No.: PCT/JP2022/000995

§ 371 Date: Jul. 10, 2023

(30) Foreign Application Priority Data
Mar. 15, 2021 (JP) 2021-041852

(51) Int. Cl. G06V 10/77; G06V 10/75

(52) U.S. Cl. CPC G06V 10/7715; G06V 10/7515

(57) ABSTRACT

An information processing apparatus according to one example embodiment includes: at least one memory configured to store instructions; and at least one processor configured to execute the instructions to: extract, from a feature map, a first feature map pertaining to a first feature, a second feature map pertaining to a second feature, and a third feature map pertaining to a third feature; determine a correspondence relationship indicating a plurality of second components associated to each first component by shifting a grid pattern indicating a plurality of the second components associated to one first component on the second feature map, based on a position of each first component, and reflect a correlation between the first feature and the second feature being calculated from the correspondence relationship, in the third feature map.

### TECHNICAL FIELD

The present invention relates to an information processing apparatus, an information processing method, and a non-transitory computer-readable medium.

### BACKGROUND ART

In recent years, various techniques using machine learning have been put into application. For example, Patent Literature 1 describes use of a neural network for learning a relationship between features extracted from an audio source, a language, or an image and classification information, in order to provide a partial highlighted segment rather than an entire segment of an audio source.

### CITATION LIST

### Patent Literature

Patent Literature 1: Published Japanese Translation of PCT International Publication for Patent Application, No. 2020-516004

### SUMMARY OF INVENTION

### Technical Problem

An object of the present disclosure is to improve the technique disclosed in Citation List.

### Solution to Problem

An information processing apparatus according to one aspect of the present example embodiment includes: an extraction means for extracting, from a feature map, a first feature map pertaining to a first feature constituted of a plurality of first components, a second feature map pertaining to a second feature constituted of a plurality of second components, and a third feature map pertaining to a third feature; a determination means for determining a correspondence relationship indicating a plurality of the second components associated to each of the first components by shifting a grid pattern indicating a plurality of the second components associated to one of the first components on the second feature map, based on a position of each of the first components; and a reflection means for reflecting a correlation between the first feature and the second feature being calculated from the correspondence relationship, in the third feature map.

An information processing method according to one aspect of the present example embodiment causes an information processing apparatus to execute: extracting, from a feature map, a first feature map pertaining to a first feature constituted of a plurality of first components, a second feature map pertaining to a second feature constituted of a plurality of second components, and a third feature map pertaining to a third feature; determining a correspondence relationship indicating a plurality of the second components associated to each of the first components by shifting a grid pattern indicating a plurality of the second components associated to one of the first components on the second feature map, based on a position of each of the first components; and reflecting a correlation between the first feature and the second feature being calculated from the correspondence relationship, in the third feature map.

A non-transitory computer-readable medium according to one aspect of the present example embodiment stores a program that causes an information processing apparatus to execute: extracting, from a feature map, a first feature map pertaining to a first feature constituted of a plurality of first components, a second feature map pertaining to a second feature constituted of a plurality of second components, and a third feature map pertaining to a third feature; determining a correspondence relationship indicating a plurality of the second components associated to each of the first components by shifting a grid pattern indicating a plurality of the second components associated to one of the first components on the second feature map, based on a position of each of the first components; and reflecting a correlation between the first feature and the second feature being calculated from the correspondence relationship, in the third feature map.

### BRIEF DESCRIPTION OF DRAWINGS

FIG. 1A is a schematic diagram illustrating a first related technique;

FIG. 1B is a schematic diagram illustrating a second related technique;

FIG. 1C is a schematic diagram illustrating an example of the present disclosure;

FIG. 2 is a block diagram illustrating the hardware configuration of the information processing apparatus according to example embodiments;

FIG. 3 is a block diagram illustrating the functional configuration of an information processing apparatus according to a first example embodiment;

FIG. 4 is a flowchart illustrating the flow of the operation of the information processing apparatus according to the first example embodiment;

FIG. 5 is a block diagram illustrating the functional configuration of an information processing apparatus according to a second example embodiment;

FIG. 6 is a flowchart illustrating the flow of the operation of the information processing apparatus according to the second example embodiment;

FIG. 7 is a schematic diagram illustrating in more detail the processing of the information processing apparatus according to the second example embodiment;

FIG. 8A is a diagram illustrating the feature maps of a query and a key according to the second example embodiment;

FIG. 8B is a diagram illustrating the feature maps of a query and a key according to the second example embodiment;

FIG. 8C is a diagram illustrating the feature maps of a query and a key according to the second example embodiment;

FIG. 8D is a diagram illustrating the feature maps of a query and a key according to the second example embodiment;

FIG. 9 is a flowchart illustrating the detailed flow of the operation of a computation unit according to the second example embodiment;

FIG. 10 is a block diagram illustrating the functional configuration of the information processing apparatus according to a third example embodiment;

FIG. 11 is a flowchart illustrating the flow of the operation of the information processing apparatus according to the third example embodiment;

FIG. 12 is a block diagram illustrating the functional configuration of the information processing apparatus according to a fourth example embodiment;

FIG. 13 is a flowchart illustrating the flow of the operation of the information processing apparatus according to the fourth example embodiment;

FIG. 14 is a block diagram illustrating the functional configuration of the information processing apparatus according to a fifth example embodiment; and

FIG. 15 is a schematic diagram illustrating the processing of the information processing apparatus according to a sixth example embodiment.

### EXAMPLE EMBODIMENT

### Related Techniques

First, an overview of related techniques is described. As a first related technique, “Non-Local Neural Networks”, Proceedings of the IEEE Conference on Computer Vision and Pattern Recognition, pp. 7794-7803, 2018, written by X. Wang, R. Girshick, A. Gupta, K. He, which is a non-patent literature, discloses a technique for improving feature extraction by obtaining a feature map from a convolutional layer of a convolutional neural network and weighting the feature map by an attention mechanism.

As a second related technique, “Exploring Self-Attention for Image Recognition”, Proceedings of the IEEE/CVF Conference on Computer Vision and Pattern Recognition, pp. 10076-10085, 2020, written by H. Zhao, J. Jia, and V. Koltun, which is also a non-patent literature, proposes a patch-based attention mechanism that differs from the first related technique in that it uses a local region (approximately 7×7) of a feature map rather than the entire space of the feature map.

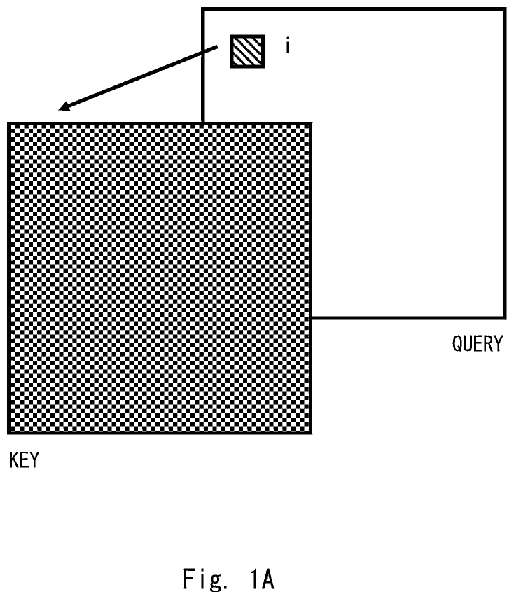

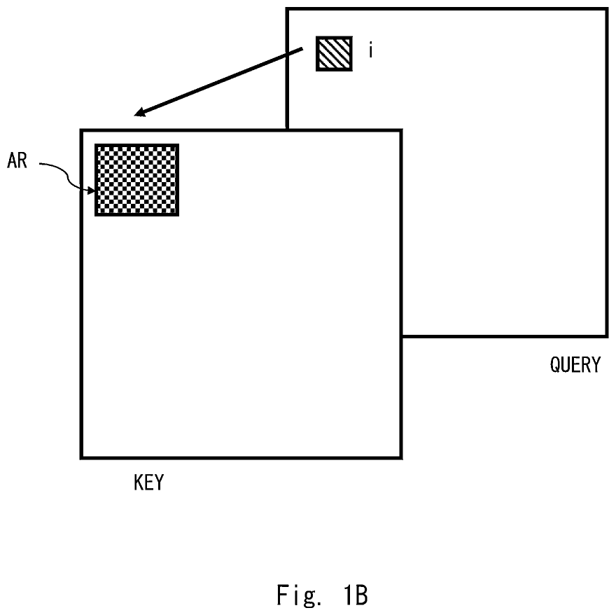

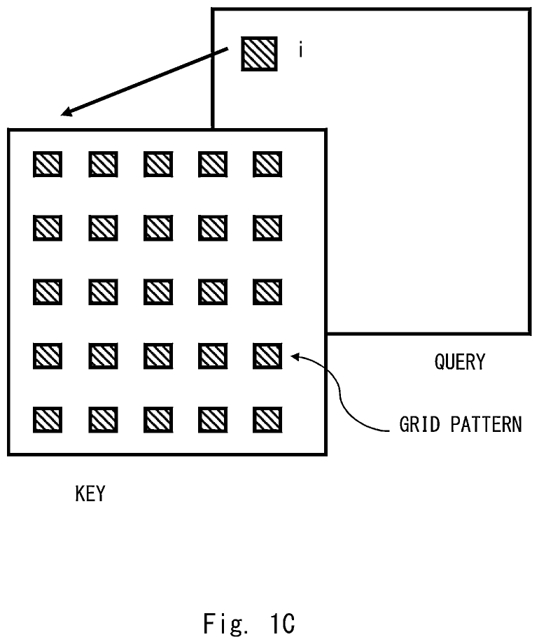

FIG. 1A is a schematic diagram illustrating the first related technique. FIG. 1A illustrates that the entire space of a key feature map is referred to for one query component (for example, a pixel) i to extract a feature. In the first related technique, the entire space of the key feature map is taken into account, thus enabling wide-area feature extraction. However, since computation is necessary for the entire key feature map, there is a problem that the computational cost becomes large.

FIG. 1B is a schematic diagram illustrating the second related technique. FIG. 1B illustrates that a partial region AR in the key feature map is referred to for query one component i to extract a feature. The partial region AR is a key component i and the surrounding neighborhood region corresponding to the query component i. The second related technique can reduce the computational cost compared to the first related technique because the region to be computed is smaller in the computation of the correlation between the two embedded features: the query and the key. However, since the partial region AR is a local region of the key feature map, another problem arises in that the advantage of wide-area feature extraction that is the original purpose of the attention mechanism may be hindered.

One of the objectives of the technique described in the following example embodiments is to solve the problems pertaining to the above-described related techniques. In other words, the present technique can provide an information processing apparatus and the like that is capable of extracting a feature taking into account the entire space of an input feature map with computation at a low computational cost.

FIG. 1C is a schematic diagram illustrating an example of the present disclosure. FIG. 1C illustrates that a grid pattern (a checkerboard pattern) region distributed throughout the space of the key feature map is referred to for one query component i to extract a feature. In the present disclosure, the grid pattern is a pattern configured of reference regions of a plurality of components in which the spacing between the reference regions of the closest components in a predetermined direction is the same on a map of arbitrary dimension. For example, on a two-dimensional map, the grid pattern may be said to be a grating pattern in which each side of a rectangle (for example, a square) unit has an arbitrary length, as well as, a pattern in which the reference region indicates a grid point in the grid pattern. Note that one unit of the reference region in the grid pattern may be constituted by one key component or may be constituted by a plurality of key components.

In the above-described technique, the entire space of the key feature map is taken into account, thus enabling wide-area feature extraction. Furthermore, since the area to be computed is not all but part of the key feature map, the necessary computational cost can be reduced. For example, when the area of the grid pattern region of FIG. 1C is the same as the area of the sub-region AR of FIG. 1B, the computational cost can be the same as the computational cost with the second related technique. However, the technique described in the present disclosure is not limited to this example. In addition, this method is applicable to various applications as described later.

### <Hardware Configuration of the Example Embodiments>

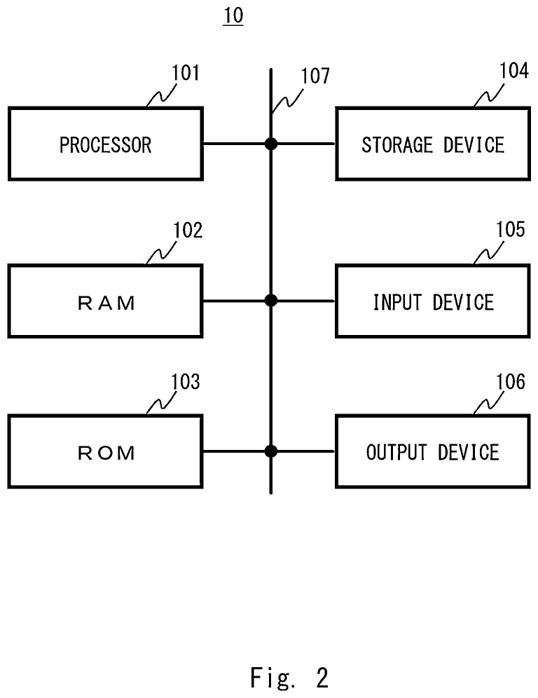

Prior to describing each example embodiment, the hardware configuration of the information processing apparatus according to the example embodiments is described with reference to FIG. 2.

As illustrated in FIG. 2, an information processing apparatus 10 includes a processor 101, a random access memory (RAM) 102, a read only memory (ROM) 103, and a storage device 104. The information processing apparatus 10 may further include an input device 105 and an output device 106. The processor 101, the RAM 102, the ROM 103, the storage device 104, the input device 105, and the output device 106 are connected via a data bus 107. This data bus 107 is used to transmit and receive data to and from the connected components.

The processor 101 reads a computer program. For example, the processor 101 is configured to read a computer program that is stored in at least one of the RAM 102, the ROM 103, or the storage device 104. Alternatively, the processor 101 may read a computer program that is stored in a computer-readable recording medium by using a recording medium reading device that is not illustrated. The processor 101 may acquire a computer program (may read a computer program) from an apparatus, not illustrated, located outside the information processing apparatus 10 via a network interface. The processor 101 controls the RAM 102, the storage device 104, the input device 105, and the output device 106 by executing the read computer program. For example, by executing a computer program the processor 101 has read, the processor 101 may realize a functional block therein for performing various processing related to a feature value. This functional block is described in detail in each example embodiment.

Examples of the processor 101 include a central processing unit (CPU), a micro processing unit (MPU), a graphics processing unit (GPU), a field-programmable gate array (FPGA), a demand-side platform (DSP), and an application specific integrated circuit (ASIC). The processor 101 may use one of the examples described above or may use a plurality of the examples in parallel.

The RAM 102 is a memory that temporarily stores a computer program to be executed by the processor 101. The RAM 102 may also temporarily store data that are temporarily used by the processor 101 while the processor 101 is executing a computer program. The RAM 102 may be, for example, a RAM such as a dynamic random access memory (DRAM) and a static random access memory (SRAM). Alternatively, other types of volatile memory may be used instead of RAM.

The ROM 103 is a memory that stores a computer program to be executed by the processor 101. The ROM 103 may also store other fixed data. The ROM 103 may be, for example, a ROM such as a programmable ROM (PROM) and an erasable programmable read only memory (EPROM). Alternatively, other types of non-volatile memory may be used instead of ROM.

The storage device 104 stores data that the information processing apparatus 10 stores over a long term. The storage device 104 may operate as a temporary storage device for the processor 101. The storage device 104 may include, for example, at least one of a hard disk device, an optical magnetic disk device, a solid state drive (SSD), or a disk array device.

The input device 105 is a device that receives an input instruction from a user of the information processing apparatus 10. The input device 105 may include, for example, at least one of a keyboard, a mouse, or a touch panel. The input device 105 may be a dedicated controller (an operating terminal). The input device 105 may also include a terminal (for example, a smartphone, a tablet terminal, and/or the like) held by a user. The input device 105 may be a device capable of audio input, including, for example, a microphone.

The output device 106 is a device that externally outputs information pertaining to the information processing apparatus 10. For example, the output device 106 may be a display device (for example, a display) capable of displaying information pertaining to the information processing apparatus 10. The display apparatus here may be a television monitor, a PC monitor, a smartphone monitor, a tablet terminal monitor, or other mobile terminal monitor. The display device may also be a large monitor, a digital signage, or the like, installed in various facilities such as a store or the like. The output device 106 may also be a device that outputs information in a format other than an image. For example, the output device 106 may be a speaker that outputs information pertaining to the information processing apparatus 10 by voice.

The following describes the functional configuration and the processing to be executed according to the example embodiments.

### First Example Embodiment

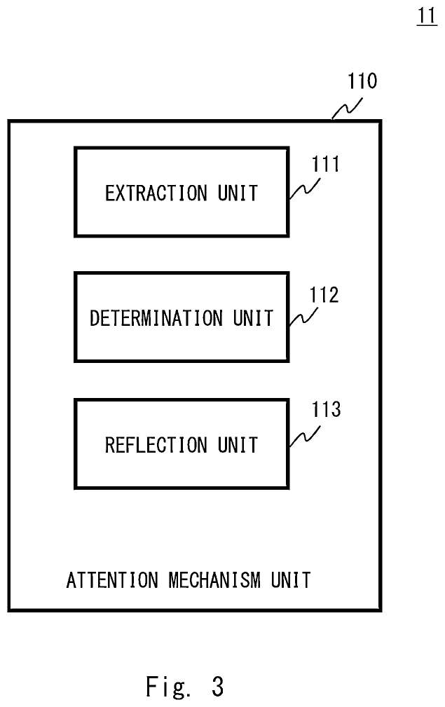

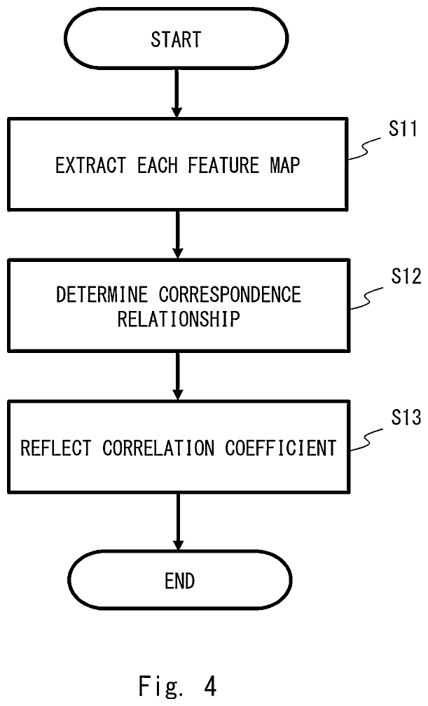

First, a first example embodiment is described with reference to FIGS. 3 and 4.

### (Functional Configuration)

FIG. 3 is a block diagram illustrating a functional configuration of the information processing apparatus according to a first example embodiment. As illustrated in FIG. 3, the information processing apparatus 11 according to the first example embodiment includes an attention mechanism unit 110 as a processing block for realizing its function. The attention mechanism unit 110 includes an extraction unit 111, a determination unit 112, and a reflection unit 113. Note that each of the extraction unit 111, the determination unit 112, and the reflection unit 113 may be realized by the processor 101 (refer to FIG. 2) described above. In other words, the processor 101 functions as components of the extraction unit 111, the determination unit 112, and the reflection unit 113 by reading and executing a computer program.

The extraction unit 111 extracts, from a feature map that has been input to the attention mechanism unit 110, a first feature map pertaining to a first feature configured of a plurality of first components, a second feature map pertaining to a second feature configured of a plurality of second components, and a third feature map pertaining to a third feature. Note that the first feature, the second feature, and the third feature may be a query, a key, and a value, respectively. In this case, the first feature map, the second feature map, and the third feature map are a query feature map, a key feature map, and a value feature map, respectively. However, the features and feature maps are not limited to this example.

The determination unit 112 determines a correspondence relationship that indicates a plurality of second components corresponding to each first component. Specifically, the determination unit 112 determines this correspondence relationship by shifting a grid pattern indicating a plurality of second components corresponding to one first component on the second feature map based on the position of each first component. Note that the definition of the grid pattern is as described above.

The correspondence relationship determined by the determination unit 112 is used to calculate a correlation between the first feature and the second feature. The reflection unit 113 performs processing for reflecting this correlation in the third feature map. In this way, the information processing apparatus 10 can extract features in an input feature map.

### (Operational Flow)

Next, the flow of the operation of the information processing apparatus 11 according to the first example embodiment is described with reference to FIG. 4. FIG. 4 is a flowchart illustrating the flow of the operation of the information processing apparatus 11 according to a second example embodiment.

As illustrated in FIG. 4, when the operation of the information processing apparatus 11 is started, the extraction unit 111 first extracts, from a feature map that has been input to the attention mechanism unit 110, a first feature map pertaining to a first feature, a second feature map pertaining to a second feature, and a third feature map pertaining to a third feature (step S11; an extraction step). Next, the determination unit 112 determines a correspondence relationship indicating a plurality of second components corresponding to each first component, (step S12; a determination step). Specifically, as described above, the determination unit 112 determines this correspondence relationship by shifting the grid pattern on the second feature map based on the position of each first component.

Finally, the reflection unit 113 reflects the correlation between the first feature and the second feature, calculated from the correspondence relationship, in the third feature map (step S13; a reflection step).

### Technical Effect

Next, a technical effect obtained by the information processing apparatus 11 according to the first embodiment is described. As described above, the determination unit 112 determines a correspondence relationship indicating a plurality of second components corresponding to each first component by using a grid pattern indicating a plurality of second components corresponding to one first component. The reflection unit 113 reflects the correlation, calculated from the correspondence relationship determined by the determining unit 112, in the third feature map. As such, the information processing apparatus 11 does not need to perform computation for the entire region of the second feature map for each first component in the computation based on the correspondence relationship, and thus the amount of computation required for the processing can be reduced. In addition, since the grid pattern allows extraction from a wider region rather than a local region of the second feature map, the information processing apparatus 11 can extract a wide range of features from the second feature map.

As described above, techniques using an attention mechanism for processing feature values are known in the image recognition field and the like. The attention mechanism is a technique for reflecting a correlation of extracted features back into the extracted features. In this attention mechanism, when attempting to perform feature extraction that takes into account the entire space of an input feature map, the computational cost increases, and conversely, when attempting to perform feature extraction that takes into account part of the feature map, there is a problem that wide-area feature extraction that is an advantage of the attention mechanism may be hindered.

On the other hand, the information processing apparatus 11 according to the first example embodiment can perform feature extraction taking into account the entire space of the input feature map with computation at a low computational cost.

### Second Example Embodiment

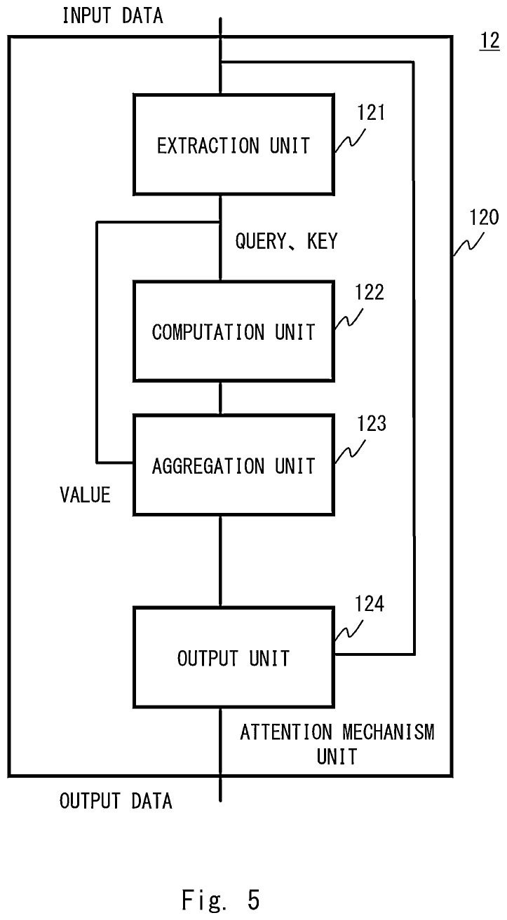

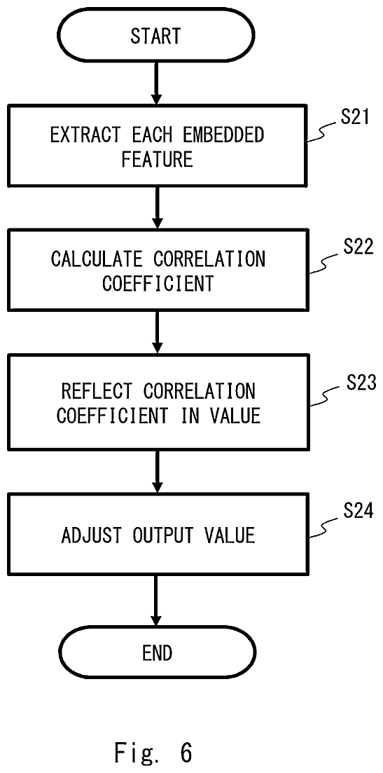

Next, a second example embodiment is described with reference to FIGS. 5 and 6. The second example embodiment describes a specific application example of the first example embodiment.

### (Functional Configuration)

FIG. 5 is a block diagram illustrating the functional configuration of the information processing apparatus according to the second example embodiment. As illustrated in FIG. 5, the information processing apparatus 12 according to the second example embodiment includes an attention mechanism unit 120 as a processing block for realizing its function. The attention mechanism unit 120 includes an extraction unit 121, a computation unit 122, an aggregation unit 123, and an output unit 124. Note that each of the extraction unit 121, the computation unit 122, the aggregation unit 123, and the output unit 124 may be realized by the above-described processor 101 (refer to FIG. 1). In other words, the processor 101 functions as components of the extraction unit 121, the computation unit 122, the aggregation unit 123, and the output unit 124 by reading and executing a computer program.

The extraction unit 121 is equivalent to the extraction unit 111 of the first example embodiment. Specifically, the extraction unit 121 acquires a feature map (a feature value) that is input data to the attention mechanism unit 120 and extracts feature maps of three embedded features necessary for the processing in the attention mechanism, a query, a key, and a value, from the acquired feature map. For the extraction unit 121, for example, a convolutional layer or a fully connected layer that is used in a convolutional neural network may be used. Furthermore, an arbitrary layer that configures a convolutional neural network may be provided at a stage prior to the extraction unit 121, and an input from such a layer may be input to the extraction unit 121 as a feature map. The extraction unit 121 outputs the extracted query and key to the computation unit 122 and outputs the value to the aggregation unit 123.

The computation unit 122 is equivalent to the determination unit 112 according to the first example embodiment. Specifically, the computation unit 122 uses embedded features of the extracted query and key to calculate a correlation (for example, Matmul) between the query and the key. Here, the computation unit 122 uses a grid pattern that enables referring to the entire space of the input feature map in the computation processing. Note that the grid pattern according to the second example embodiment is a grid-shaped pattern in which one unit is configured of a square and one grid point (one unit of a reference region) is configured of one key component.

The computation unit 122 may determine a correlation by calculating a matrix product after performing a tensor shape conversion (reshape) on the embedded query and key features. The computation unit 122 may also determine a correlation by combining the two embedded features after performing a tensor shape conversion on the embedded query and key features. The computation unit 122 further performs computation of convolution and rectified linear function (ReLU; rectified linear unit) on the matrix product or combined features calculated as described above to acquire a feature map indicating a final correlation.

Note that the computation unit 122 may further be provided with a convolutional layer for convolution. In addition, the computation unit 122 may or may not normalize the feature map indicating the obtained correlation on a scale of 0 to 1 by using a sigmoid function, a softmax function, or the like. The feature map indicating the calculated correlation is input into the aggregation unit 123.

The aggregation unit 123 is equivalent to the reflection unit 113 according to the first example embodiment. Specifically, the aggregation unit 123 carries out processing for reflecting a correlation between a query and a key into a value feature map by using a feature map indicating the correlation calculated by the computing unit 122 and the value that is an embedded feature extracted by the extraction unit 121. This processing reflects the correlation by computing a Hadamard product of the feature map of the correlation (weight) calculated by the computation unit 122 and the value. The feature map in which the correlation is reflected is input to the output unit 124.

The output unit 124 performs adjustment processing for passing the calculated feature map to the feature extraction unit at a stage following the attention mechanism unit 120. The output unit 124 mainly performs linear conversion processing and residual processing as adjustment processing. The output unit 124 may process the feature map by using a 1×1 convolutional layer or a fully connected layer as linear conversion processing. However, the output unit 124 may perform residual processing without undergoing this linear conversion processing.

The output unit 124 may perform processing of adding the feature that has been input into the extraction unit 121 and the feature map output from the aggregation unit 123 as residual processing. This is to prevent the feature map from not being generated by the output unit 124 even when the correlation is not calculated. When 0 is calculated as a correlation (weight), the value is multiplied by that 0, and thus the feature value becomes 0 (disappears) in the feature map output by the aggregation unit 123. To prevent this, the output unit 124 performs residual processing to add the feature of the input map at this timing in such a way that the feature value does not become 0 even when 0 is calculated as a correlation. The output unit 124 outputs the feature map on which adjustment processing has been performed as the output data.

### (Operational Flow)

Next, the flow of the operation of the information processing apparatus 12 according to the second example embodiment is described with reference to FIG. 6. FIG. 6 is a flowchart illustrating the flow of the operation of the information processing apparatus according to the second example embodiment.

As illustrated in FIG. 6, when the operation of the information processing apparatus 12 according to the second example embodiment is started, the extraction unit 121 first extracts embedded features from a feature map that has been input (step S21). Next, the computation unit 122 uses a query and a key that are the extracted embedded features to calculate a feature that indicates a correlation between the two (step S22).

The aggregation unit 123 then reflects the correlation in a value that is the input feature (step S23). Finally, the output unit 124 adjusts a response value of the feature map in order to output the feature map that was extracted by the aggregation unit 123 (step S24).

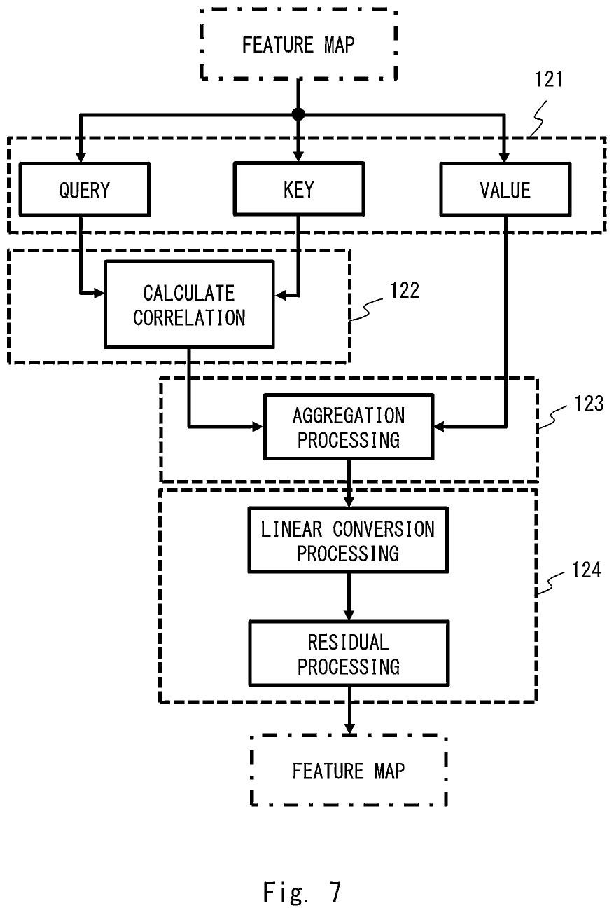

FIG. 7 is a schematic diagram illustrating the processing of the information processing apparatus 12 in more detail; the detail of the processing is described with reference to FIG. 7. A feature map that has been input to the attention mechanism unit 120 is divided by the extraction unit 121 into feature maps of a query, a key, and a value. Then, the computation unit 122 calculates a feature that indicates a correlation between the query and the key. The aggregation unit 123 reflects the calculated correlation in the value extracted by the extraction unit 121 to generate a feature map. The output unit 124 adjusts a response value of the feature map by executing linear response processing and residual processing on the feature map to generate a new feature map. Note that the arrows illustrated in FIG. 7 simply outline the flow of data described in the present example embodiment and do not prevent the data processing from being carried out in other aspects by the attention mechanism unit 120. In other words, the depiction of FIG. 7 does not preclude the data from being exchanged bidirectionally by the units of the attention mechanism unit 120.

### (Details of Referring to the Key Feature Map)

Details of a method in which the computation unit 122 refers to a key feature map are further described. In the technique described in the present disclosure, a grid pattern is used when determining a key reference position corresponding to a specific query position i. Specifically, the computation unit 122 can refer to all the features in the space of the key by referring to a key feature map (a second feature map) while shifting a grid pattern from within a sub-region (a divided region) in a query feature map (a first feature map). In addition, by making use of the characteristics in which all components in the space of the key can be referred to from within a sub-region of the query, the computation unit 122 can evenly refer to the entire space of the key from within each sub-region of the query by referring to the key feature map while repeatedly shifting a grid pattern within other sub-regions of the query.

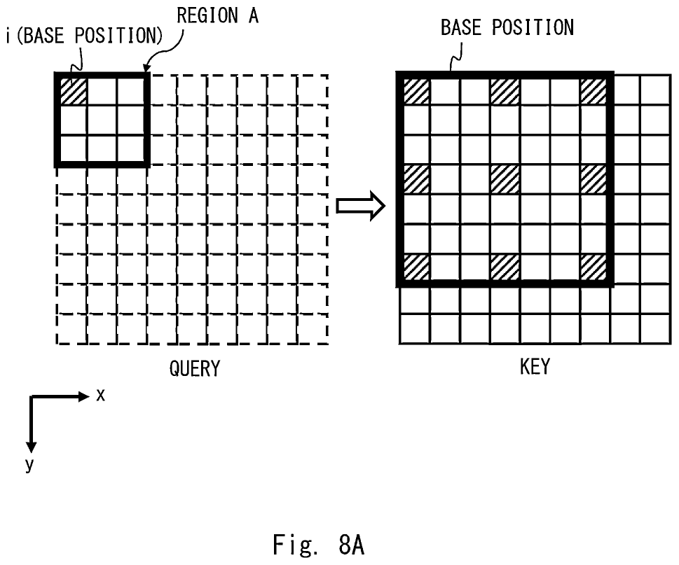

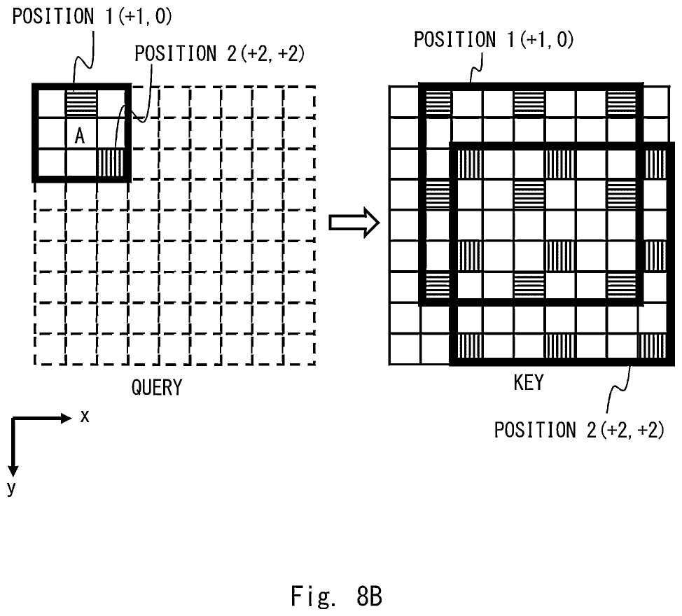

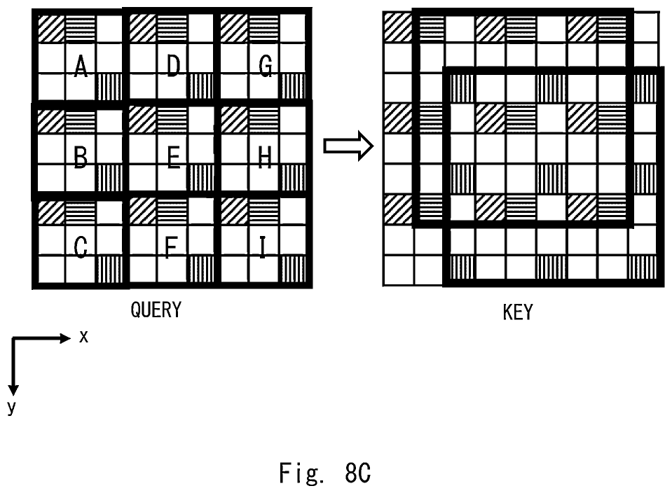

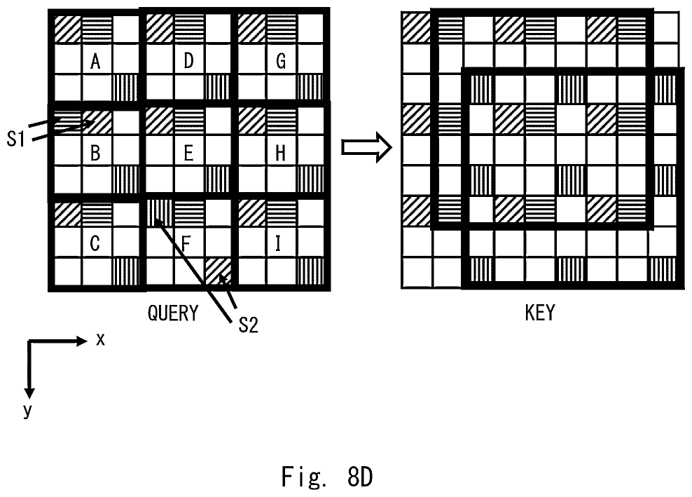

With reference to the drawings of the feature maps of a query and a key illustrated in FIGS. 8A to 8D, the reference positions of each of the query and the key are further described. Note that, in the examples of FIGS. 8A to 8D, input data are image data, and the components thereof are pixels. In FIGS. 8A to 8D, the horizontal direction in each square feature map is set to an x direction and the vertical direction is set to a y direction.

FIG. 8A illustrates base positions that are a plurality of key reference positions when a reference position i on a query side is assumed as a base position. The region surrounded by a bold line in the query of FIG. 8A indicates a 3*3 square region A that is a sub-region (a block region) of the query, and the region surrounded by a bold line in the key indicates a reference region pertaining to the query i. The base position of the query is an upper-left pixel in the region A.

As illustrated in FIG. 8A, in the technique described in the present disclosure, the computation unit 122 refers to a key embedded feature generally coarsely in such a way that the key embedded feature forms a grid shape. In the specific example of FIG. 8A, in the 7*7 reference region of the key, keys that become actual reference targets of the key are 9 pixels. The computation unit 122 determines the reference positions of the key by using the size N*N of the feature maps of the key and query and a division number S. The size B*B of the sub-region of the query in a dashed line region is calculated by B=N/S. The skipping width in the reference region of the key (the size of a grid, that is, the positional displacement amount between the closest key components as reference targets in the x-axis direction or the y-axis direction) is also B. Note that, although, in the example of FIG. 8A, the size of the feature map is 9×9 and the division number S is 3, the values of the size and the division number are not limited thereto. In this manner, the computation unit 122 calculates a grid pattern pertaining to the base positions.

FIG. 8B illustrates key reference positions when a query reference position in the region A is shifted from a base position. A position 1 on the query side is a position when a query reference position is shifted by +1 in the x-axis direction from the base position, and a position 2 on the query side is a position when a query reference position is shifted by +2 in the x-axis direction and +2 in the y-axis direction from the base position. In this manner, when a query reference position i is shifted within the region A, the computation unit 122 shifts the key reference positions by the same amount as the displacement amount (movement amount) in the x-axis and y-axis in the query. In other words, when a query reference position is at the position 1, the computation unit 122 sets the grid pattern of the key (the reference positions) to positions 1 shifted by +1 in the x-axis direction, and, when a query reference position is at the position 2, the computation unit 122 sets the grid pattern of the key (the reference positions) to positions 2 shifted by +2 in the x-axis direction and +2 in the y-axis direction. Through the above processing, the computation unit 122 can refer to the entire space of the feature map in the key from within a sub-region of the query.

FIG. 8C illustrates a state in which the query feature map is divided into nine sub-regions A to I. After the correspondence relationship between the query in the sub-region A and the key is set as described above, the computation unit 122 derives a displacement amount in the x-axis direction and y-axis direction with the upper-left block in each sub-region being a base position for each query in each sub-region B to I of the query. Then, the computation unit 122 determines keys corresponding to each query in each sub-region B to I by referring to a grid pattern that is shifted by using the displacement amount in the key feature map in a similar way to each query in the sub-region A. In this way, the same hatching in the query map in FIG. 8C refers to the same position of the grid pattern in the key feature map. As a result, the computation unit 122 can thoroughly refer to the entire space of the embedded key feature map from within each sub-region of the query.

### (Details of Regularization Method)

Further, a regularization method introduced in the technique described in the present disclosure is described. In the processing thus far, the position of a grid pattern corresponding to a query is fixed. Accordingly, there is a possibility that the computation unit 122 cannot accurately extract features when there is no change in the pose, position, or the like of an object in input image data being learned and when a change in the pose, position, or the like of the object occurs in input image data being operated. To prevent this, the computation unit 122 performs processing of shuffling (replacing) the grid patterns of a key corresponding to a query randomly and with a constant probability.

FIG. 8D illustrates that portions of the sub-regions B and F are shuffled relative to the example illustrated in FIG. 8C. The shuffled region for a portion of the sub-region B is indicated as region S1, and the shuffled region for a portion of the sub-region F is indicated as region S2. The computation unit 122 can flexibly change (increase) the variation of the grid pattern corresponding to a query by making such a shuffle, thus enabling robust feature extraction with respect to a change in the pose and position of an object in input image data.

It is preferable that a plurality of keys to be shuffled are in the same sub-region. As such, the computation unit 122 can reliably execute the shuffling processing.

### (Detailed Operational Flow)

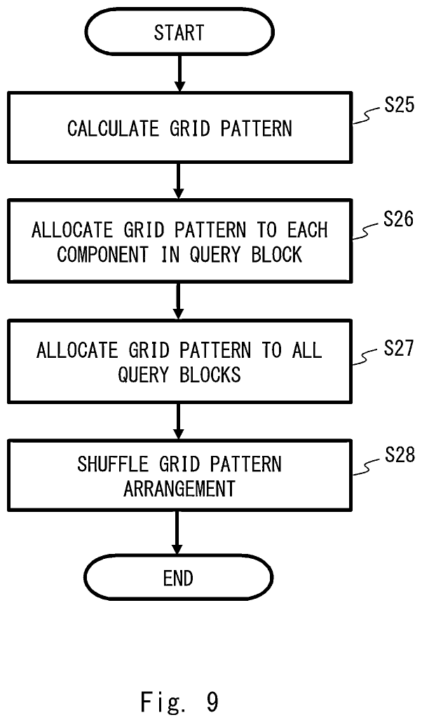

Next, the detailed operational flow of the computation unit 122 is described with reference to FIG. 9. FIG. 9 is a flowchart illustrating the flow of the detailed operation of the computation unit 122.

First, the computation unit 122 calculates a grid pattern for a base position by using a key embedded feature (step S25). Then, by shifting the calculated checkerboard pattern by using the displacement amount from the base position within a sub-region of a query, the computation unit 122 allocates grid patterns to all the components within a sub-region of the query (step S26).

The computation unit 122 then allocates grid patterns to all the other sub-regions of the query in a similar manner (step S27). Then, the computation unit 122 introduces processing of shuffling the allocated grid patterns at an arbitrary position within the block of the key with a constant probability (step S28). Note that the details of each of these steps are as described in the description with reference to FIGS. 8A to 8D. In this way, the computation unit 122 allocates a grid pattern to a query for each position of the query feature map.

### Technical Effect

Next, a technical effect obtained by the information processing apparatus 12 according to the second example embodiment is described.

The attention mechanism of the first non-patent literature that is a related technique needs to refer to positions over the entire space of an embedded key feature with regard to a pixel i of a query in order to refer to the entire feature value with regard to the pixel i at a specific position of the query. When an input to the attention mechanism is an image or another two-dimensional feature map, the computation amount to be performed is likely to depend on the input resolution, thus, it is difficult to use this attention mechanism in image recognition tasks that handle images with high resolution.

On the other hand, the attention mechanism of the second non-patent literature greatly reduces the computation amount to be performed by referring to key positions within a local region (approximately 7*7) for a pixel i at a specific position of a query in order to reduce the computation amount dependent on the resolution. However, this technique makes it difficult to refer to the entire space of a feature map, lowering the feature extraction capability of the attention mechanism.

In contrast, the technique described in the present disclosure can refer to the entire space of the feature map by efficiently by using the grid pattern with a smaller computation amount than the technique of the first non-patent literature (for example, a computation amount equivalent to the second non-patent literature). In this way, the information processing apparatus can refer to a wide feature space more easily, improving the feature extraction capability of the attention mechanism.

In the technique of the first non-patent literature, when an image having an enormous number of dimensions of information is input to the attention mechanism, the computation amount of the attention mechanism increases with the square of the resolution. In such a case, the technique is difficult to be put in use from the viewpoint of practical application. The information processing apparatus 12 according to the present example embodiment provides a remarkable technical effect in that it is possible to suppress such a state in which the computational processing load becomes extremely large.

In addition, the computation unit 122 (the determination unit) can determine the correspondence relationship between a query component (the first component) and a key component (the second component) as follows. The computation unit 122 shifts a grid pattern on the key feature map based on the position of each query component in such a way that key components correspond to at least one query component. In this manner, the computation unit 122 can thoroughly refer to the entire space of the key feature map. Thus, the attention mechanism unit 120 can extract all the features of input data.

In addition, the computation unit 122 can determine the correspondence relationship between a query component and a key component as follows. The computation unit 122 divides a query feature map (the first feature map) into a plurality of sub-regions (divided regions) and shifts a grid pattern on a key feature map based on the position of each query component in such a way that key components correspond to at least any one query component in a sub-region. In this manner, the computation unit 122 can thoroughly refer to the entire space of the key feature map each time the computation unit 122 refers to a sub-region of the query. Thus, the attention mechanism unit 120 can unbiasedly and widely extract features of input data.

The computation unit 122 can also determine the correspondence relationship by shifting the grid pattern on the key feature map based on the position of each query component in such a way that each key component corresponds to any one query component in each sub-region. Thus, the attention mechanism unit 120 can extract features of input data more unbiasedly.

The computation unit 122 can also shift the grid pattern on the key feature map based on the position of each query component as follows. In other words, the computation unit 122 can set the query components that correspond one-to-one with each other in all the divided regions and set the grid pattern on the key feature map to be placed at the same positional relationship as the corresponding query components. By making the method of shifting the grid pattern such a simple setting, the computation unit 122 can reduce the computational cost for thoroughly referring to features of input data.

In addition, the computation unit 122 may determine the correspondence relationship by shuffling, with a predetermined probability, the position of the grid pattern on the key feature map that is determined in accordance with the position of each query component. As a result, the attention mechanism unit 120 can perform robust feature extraction with respect to a change in the pose or position of an object in input image data.

The computation unit 122 can also configure the sub-region of a query in a congruent shape (for example, a square) that includes a plurality of key components. Thus, by making the setting of the sub-region in such a simple way, the computation unit 122 can reduce the computational cost for thoroughly referring to features of input data.

### Third Example Embodiment

Next, a third example embodiment is described with reference to the drawings. The third example embodiment illustrates an example in which the information processing apparatus 11 constructs a single network by repeatedly stacking the attention mechanism unit 120 described in the second example embodiment. Note that the third to fifth example embodiments describe specific application examples of the attention mechanism unit 120 described in the second example embodiment. Thus, some of the configurations and processing that are different from those of the second example embodiment may be described in the description of the third to fifth example embodiments, and other configurations and processing that are not described may adopt the configurations and processing that are common to the second example embodiment. Also, components that are assigned the same signs perform the same processing in the description of the third to fifth example embodiments.

### (Functional Configuration)

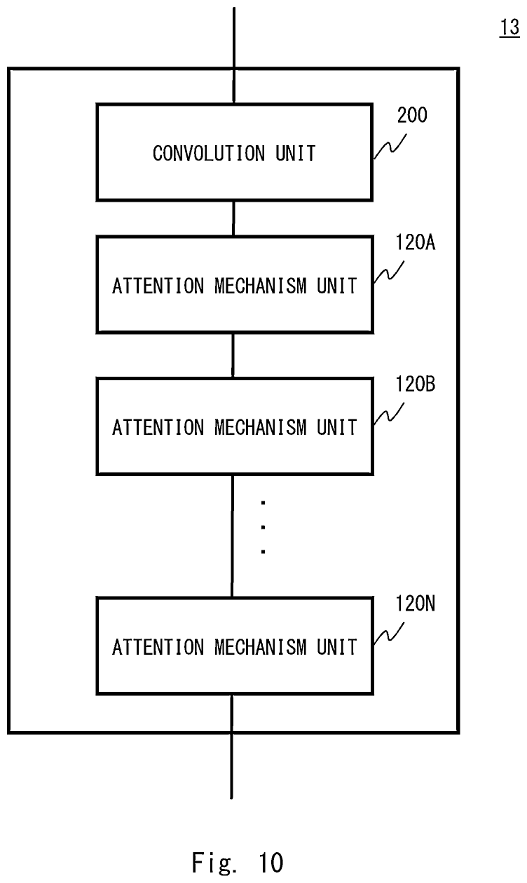

The third example embodiment using the information processing apparatus 13 is described with reference to FIG. 10. FIG. 10 is a block diagram illustrating the functional configuration using the information processing apparatus 13. The information processing apparatus 13 includes a convolution unit (a feature extraction unit) 200 and a plurality of attention mechanism units 120. The information processing apparatus 13 is provided with, at the foremost stage, a convolution unit 200 that is used in a convolutional neural network with which the information processing apparatus 13 can extract a feature map from an input image that has been input. The convolution unit 200 is a unit that performs feature extraction on the key feature map by using a convolution layer with a local kernel (approximately 3×3). After that, the information processing apparatus 13 repeatedly arranges the attention mechanism unit 120 for a specified number of times. The information processing apparatus 13 finally arranges an output layer (not illustrated) therein that outputs a certain result for the input image to construct the entire network.

### (Operational Flow)

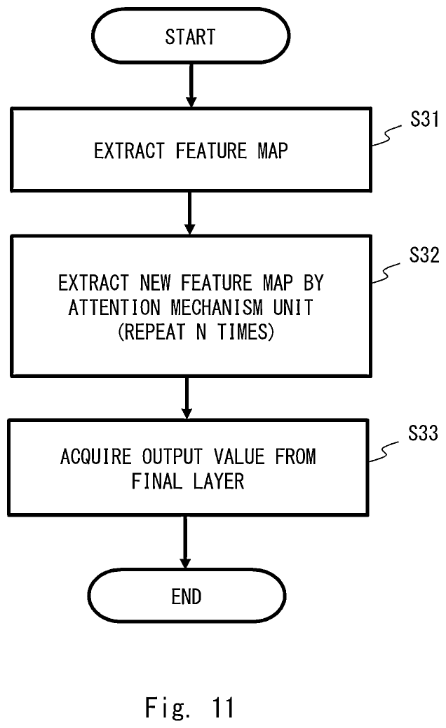

Next, the flow of the operation of the information processing apparatus 13 according to the third example embodiment is described with reference to FIG. 11. FIG. 11 is a flowchart illustrating the flow of the operation of the information processing apparatus 13 according to the third example embodiment.

As illustrated in FIG. 11, when the operation of the information processing apparatus 13 is started, the convolution unit 200 first extracts a feature map from image data that have been input (step S31). Subsequently, the feature map that has been output at step S31 is input into the attention mechanism unit 120 and converted into a new feature map in the attention mechanism unit 120 (step S32). Step S32 is repeatedly performed for a specified number of N times (that is, the number of times the attention mechanism unit 120 is provided) to extract a new feature map. Subsequently, after completing all processing of the attention mechanism unit 120, the information processing apparatus 13 obtains a response value from the final output layer (step S33).

### Technical Effect

The following describes a technical effect obtained by the information processing apparatus 13 according to the third example embodiment. As described with reference to FIGS. 10 and 11, a network is constructed by using a plurality of attention mechanism units 120 in the information processing apparatus 13 according to the third example embodiment. The attention mechanism unit 120 can refer to a wide feature space with a small computation amount as described in the first example embodiment. Therefore, the information processing apparatus 13 can construct a network that is specialized in extracting features from the entire image. Specifically, the information processing apparatus 13 is considered to be particularly effective for tasks that require feature extraction from a wide range of information, such as an image recognition task that recognizes a landscape.

### Fourth Example Embodiment

Next, a fourth example embodiment is described with reference to the drawings. The fourth example embodiment illustrates an example of constructing a network by repeatedly stacking the attention mechanism unit 120 that is a technique described in this disclosure and a convolution unit (a feature extraction unit) 200. As described above, the convolution unit 200 is a unit that performs feature extraction by using a convolution layer with a local kernel (approximately 3×3).

### (Functional Configuration)

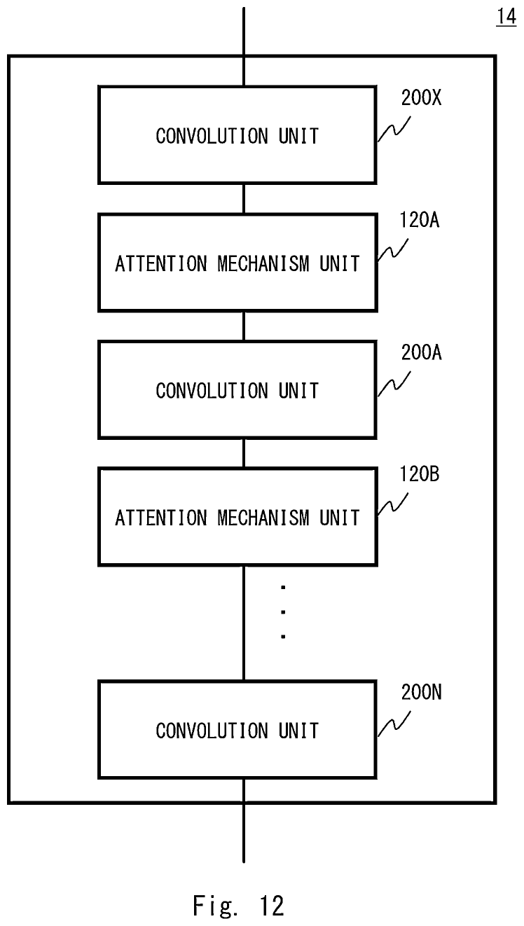

A fourth example embodiment using the attention mechanism unit 120 and the convolution unit 200 is described with reference to FIG. 12. FIG. 12 is a block diagram illustrating the functional configuration of an information processing apparatus 14 that includes the attention mechanism unit 120 and the convolution unit 200. The information processing apparatus 14 is provided with a convolution unit 200X at the foremost stage thereof, which allows information processing apparatus 14 to extract a feature map from an input image. Then, at the following stage, the attention mechanism unit 120 and the convolution unit 200 are repeatedly arranged for a specified number of times. Here, the order in which the attention mechanism unit 120 and the convolution unit 200 are arranged and how to arrange which units in succession can be freely determined by a designer. In the example of FIG. 12, a plurality of pairs of the attention mechanism unit 120 at front and the convolution unit 200b at back are provided in the information processing apparatus 14. Finally, an output layer (not illustrated) that outputs a certain result for the input image is arranged to construct a single network in the information processing apparatus 14.

### (Operational Flow)

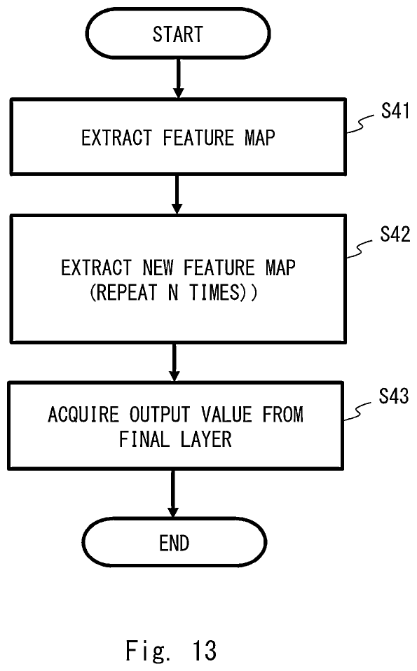

The following describes the flow of the operation of the information processing apparatus 14 according to the fourth example embodiment with reference to FIG. 13. FIG. 13 is a flowchart illustrating the flow of the operation of the information processing apparatus 14 according to the fourth example embodiment.

As illustrated in FIG. 13, when the operation of the information processing apparatus 14 according to the fourth example embodiment is started, the convolution unit 200X at the foremost stage first extracts a feature map from image data that have been input (step S41). Subsequently, the feature map that has been output at step S41 is input into the attention mechanism unit 120 or the convolution unit 200 at the following stage and is converted into a new feature map by each unit (step S42). Step S42 is repeatedly performed for a specified number of N times (that is, N times is the number of times the attention mechanism unit 120 and the convolution unit 200 are provided) to extract a new feature map at each repetition. Finally, upon completing all the feature map extraction processing at step S42, the information processing apparatus 14 obtains a response value from the final output layer (step S43).

### Technical Effect

The following describes a technical effect obtained by the information processing apparatus 14 according to the fourth example embodiment. As described with reference to FIGS. 12 and 13, a network is constructed by using the attention mechanism unit 120 that is the technique described in this disclosure and the convolution unit 200 in the information processing apparatus 14 according to the fourth example embodiment. The convolution unit 200 performs feature extraction by using a convolution layer with a local kernel (approximately 3×3) as a predetermined range of kernel, enabling feature extraction focusing on a local region in data. Therefore, the information processing apparatus 14 can construct a network that enables feature extraction taking into account two perspectives: an overall image and a local region of the image. The information processing apparatus 14 can improve various types of recognition performance, such as general object recognition and object detection in situations where objects of various types and sizes are mixed in an image.

### Fifth Example Embodiment

Next, a fifth example embodiment is described with reference to the drawings. The fifth example embodiment constructs a network by repeatedly stacking the attention mechanism unit 120 that is a technique described in the present disclosure and a patch-based attention mechanism unit (a feature extraction unit) 210. The patch-based attention mechanism unit 210 is adopted from the patch-based attention mechanism described in the second non-patent literature, which is a unit that performs feature extraction on the key feature map by using a convolutional layer for a partial patch region (approximately 7*7) as illustrated in FIG. 1C. Note that the description of the patch-based attention mechanism described in the second non-patent literature is incorporated in the present disclosure.

### (Functional Configuration)

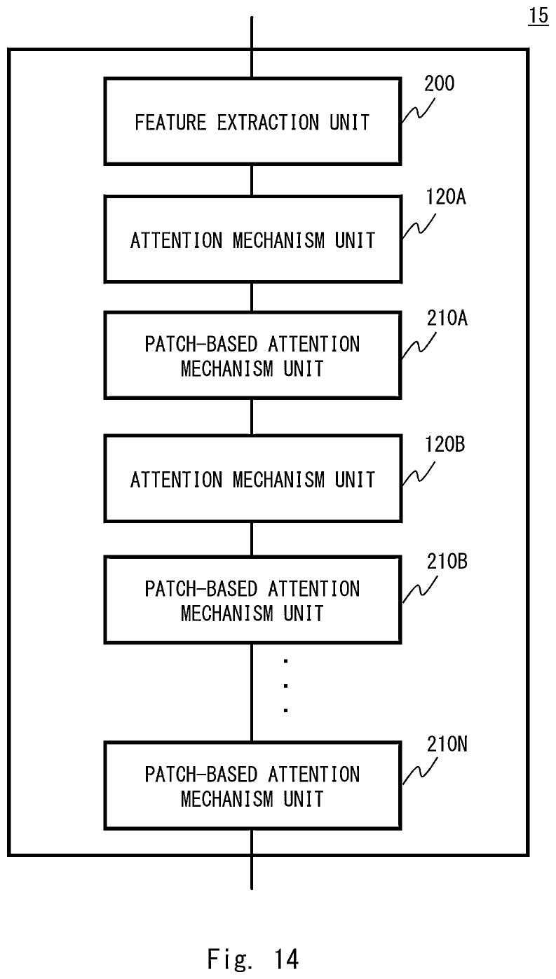

The fourth example embodiment using the attention mechanism unit 120, the convolution unit 200, and the patch-based attention mechanism unit 210 is described with reference to FIG. 14. FIG. 14 is a block diagram illustrating the functional configuration of an information processing apparatus 15 that includes an attention mechanism unit 120, a convolution unit 200, and a patch-based attention mechanism unit 210. The information processing apparatus 15 is provided with a convolution unit 200 at the foremost stage of the processing thereof, which allows extraction of a feature map from an input image. Then, at the following stage, the attention mechanism unit 120 and the patch-based attention mechanism unit 210 are repeatedly arranged for a specified number of N times. Here, the order in which the attention mechanism unit 120 and the patch-based attention mechanism unit 210 are arranged and how to arrange which units in succession can be freely determined by a designer. In the example of FIG. 14, a plurality of pairs of the attention mechanism unit 120 at front and the patch-based attention mechanism unit 210 at back are provided in the information processing apparatus 15. Finally, an output layer (not illustrated) that outputs a certain result for the input image is arranged to construct the entire network in the information processing apparatus 15.

### (Operational Flow)

Next, the flow of the operation of the information processing apparatus 15 according to the fifth example embodiment is described with reference to FIG. 13. Note that points that are the same as the points of the fourth example embodiment are omitted from the description.

The feature map that has been output at step S41 is input into the attention mechanism unit 120 or the patch-based attention mechanism unit 210 at the following stage and is converted into a new feature map by each unit (step S42). Step S42 is repeatedly performed for a specified number of N times (that is, the number of times the attention mechanism unit 120 and the patch-based attention mechanism unit 210 are provided). The information processing apparatus 15 then performs the processing of step S43.

### Technical Effect

The following describes a technical effect obtained by the information processing apparatus 15 according to the fifth example embodiment. As described with reference to FIGS. 13 and 14, a network is constructed by using an attention mechanism unit 120 and a patch-based attention mechanism unit 210 in the information processing apparatus 15 according to the fifth example embodiment. The patch-based attention mechanism unit 210 performs feature extraction by using a convolution layer with a local kernel (approximately 7×7) as a predetermined range of kernel, enabling feature extraction focusing on a local area in data. The patch-based attention mechanism unit 210 has the same function as the convolution unit 200 in extracting features from a local region but is superior to the convolution unit 200 in accuracy and computation amount. Therefore, a higher-performance network can be constructed by using the patch-based attention mechanism unit 210 instead of the convolution unit 200. For these reasons, a network can be constructed that enables feature extraction taking into account two perspectives: an overall image and a local region of the image. Specific application examples of the information processing apparatus 15 are similar to those of the fourth example embodiment, and the information processing apparatus 15 is believed to improve various types of recognition performance such as general object recognition and object detection in situations where objects of various types and sizes are mixed in an image.

### Sixth Example Embodiment

Next, a sixth example embodiment is described with reference to the drawings. The example embodiments thus far have described the operations of the information processing apparatuses that process tasks involving images using a two-dimensional feature map as an example. However, the technique of the present disclosure can be applied even when the input data are one-dimensional data such as voice and natural language processing, as well as, two-dimensional data such as an image.

### (Functional Configuration)

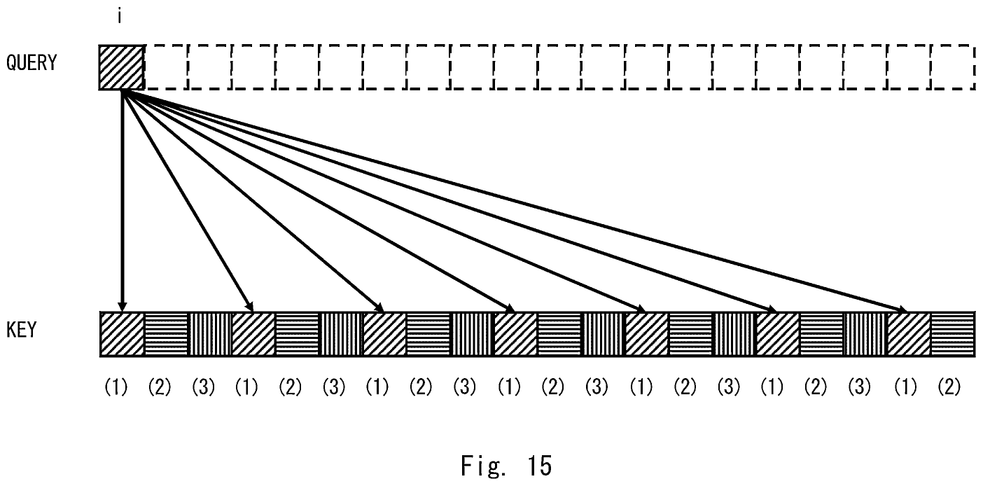

With reference to FIG. 15, an information processing apparatus 16 when using a one-dimensional feature is described. An overview of the functional configuration of the information processing apparatus is as illustrated in FIG. 3, and is described hereinafter with particular reference to differences from the first example embodiment.

The extraction unit 111 extracts, from a feature map that has been input to the attention mechanism unit 110, a first feature map pertaining to a first feature configured of a plurality of first components, a second feature map pertaining to a second feature configured of a plurality of second components, and a third feature map pertaining to a third feature. In the sixth example embodiment, the first feature, the second feature, and the third feature are a query, a key, and a value, respectively. Each feature map is a one-dimensional map.

The determination unit 112 determines a correspondence relationship that indicates a plurality of key components corresponding to each query component. Specifically, the determination unit 112 determines this correspondence relationship in such a way that key components correspond to at least one query component by shifting a grid pattern indicating a plurality of key components corresponding to one query component on the key feature map based on the position of each query component. In other words, the correspondence relationship indicates a correspondence relationship of a plurality of key components corresponding to each query component. In the present disclosure, the grid pattern is a pattern in which the spacing between the closest key components (reference regions) is the same in a one-dimensional map. Note that the size of the grid is 3 in FIG. 15. Thus, even when the technique of the present disclosure is applied to a one-dimensional feature vector, the determination unit 112 can determine the closest key reference positions with an equal interval, as in the case of a two-dimensional feature map.

Then, the reflection unit 113 performs processing for reflecting a correlation between the query and the key, calculated from the correspondence relationship determined by the determining unit 112, into the value feature map. In this way, the information processing apparatus 10 can extract features in the input feature map.

### (Operational Flow)

First, the extraction unit 111 extracts the feature maps of a query, a key, and a value from a feature map that has been input to the attention mechanism unit 110. The determination unit 112 refers to a specified grid pattern corresponding to a particular query component (a base position). In FIG. 15, a grid pattern (1) is specified for a query component i.

Subsequently, for a query component that is shifted from the base position, the determination unit 112 specifies and assigns, as a grid pattern for reference, a grid pattern (2) or (3) that has been shifted from the grid pattern (1) by the same amount as the shifted amount of query component. At this time, the determination unit 112 may randomly change the key grid pattern to be referred to with respect to a query component, with a predetermined probability, as in the case of a two-dimensional feature map. In addition, a network may be constructed with the attention mechanism unit described in the present disclosure as in the third example embodiment, or a network may be constructed by combining the attention mechanism unit described in the present disclosure and a different feature extraction unit as in the fourth and fifth example embodiments. A correlation between the query and the key is calculated from this correspondence relationship determined by the determination unit 112. The reflection unit 113 then reflects the correlation in the value feature map.

### Technical Effect

The sixth example embodiment can also be applied to tasks involving one-dimensional data such as voice and natural language processing as well as tasks involving images.

Note that the present invention is not limited to the above-described embodiments, and can be modified as appropriate to the extent that the present invention does not deviate from the spirit of the present invention.

For example, in the second example embodiment, one unit of the grid pattern is a square. However, one unit of the grid pattern may be a rectangle of any shape, rather than a square.

In the second example embodiment, an example in which a component at the same position within each sub-region of a query corresponds to a grid pattern at the same position (except when shuffled) has been described. However, as long as the correspondence relationship is determined in such a way that the entire space of the key feature map is thoroughly referred to from within each sub-region of a query, the position of the query component within a sub-region, corresponding to the grid pattern at the same position, may be set at a different position in two or more sub-regions.

The computation unit 122 may configure a sub-region of the query in a different shape having the same area, rather than a congruent shape including a plurality of key components.

In the third to fifth example embodiments, the attention mechanism unit 110 may be stacked within the information processing apparatus instead of the attention mechanism unit 120. In addition, even when processing data of arbitrary dimension other than two-dimensional data (for example, one-dimensional data or three-dimensional data), the attention mechanism unit described in the present disclosure can be stacked within the information processing apparatus, as in the examples described in the third to fifth example embodiments.

The one or a plurality of processors included in each apparatus according to the above-described embodiments execute one or a plurality of programs including a group of instructions for causing a computer to perform the algorithms described with reference to each drawing. Through this processing, the signal processing method described in the example embodiments can be realized.

The program may be stored and supplied to a computer by using various types of non-transitory computer-readable media. The non-transitory computer-readable media include various types of tangible storage media. Examples of the non-transitory computer-readable medium include a magnetic recording medium (for example, a flexible disk, a magnetic tape, and a hard disk drive), an optical magnetic recording medium (for example, an optical magnetic disk), a CD-ROM (read only memory), a CD-R, a CD-R/W, a semiconductor memory (for example, a mask ROM, a programmable ROM (PROM), an erasable ROM (EPROM), a flash ROM, and a random access memory (RAM)). The program may also be supplied to a computer by various types of transitory computer-readable media. Examples of the transitory computer-readable medium include electrical signals, optical signals, and electromagnetic waves. The transitory computer-readable medium can supply a program to a computer via a wired communication channel, such as electrical wires and optical fibers, or a wireless communication channel.

Some or all of the above example embodiments may also be described as in the following supplementary notes, but are not limited to:

### (Supplementary Note 1)

An information processing apparatus including:
an extraction unit configured to extract, from a feature map, a first feature map pertaining to a first feature constituted of a plurality of first components, a second feature map pertaining to a second feature constituted of a plurality of second components, and a third feature map pertaining to a third feature;
a determination unit configured to determine a correspondence relationship indicating a plurality of the second components associated to each of the first components by shifting a grid pattern indicating a plurality of the second components associated to one of the first components on the second feature map, based on a position of each of the first components;
a reflection unit configured to reflect a correlation between the first feature and the second feature that are calculated from the correspondence relationship, in the third feature map.

### (Supplementary Note 2)

The information processing apparatus according to supplementary note 1, wherein the determination unit determines the correspondence relationship by shifting the grid pattern on the second feature map based on a position of each of the first components in such a way that each of the second components is associated to at least one of the first components.

### (Supplementary Note 3)

The information processing apparatus according to supplementary note 2, wherein the determination unit determines the correspondence relationship by dividing the first feature map into a plurality of divided regions and shifting the grid pattern on the second feature map, based on a position of each of the first components in such a way that each of the second components is associated to at least any one of the first components in each of the divided regions.

### (Supplementary Note 4)

The information processing apparatus according to supplementary note 3, wherein the determination unit determines the correspondence relationship by shifting the grid pattern on the second feature map based on a position of each of the first components in such a way that each of the second components is associated to any one of the first components in each of the divided regions.

### (Supplementary Note 5)

The information processing apparatus according to supplementary note 4, wherein the determination unit determines the correspondence relationship by setting the first components that are associated one-to-one with each other in all the divided regions and shifting the grid pattern on the second feature map, based on a position of each of the first components in such a way that the grid pattern is placed at the same position on the second feature map with the associated first components.

### (Supplementary Note 6)

The information processing apparatus according to supplementary note 5, wherein the determination unit determines the correspondence relationship by shuffling, with a predetermined probability, a position, on the second feature map, of the grid pattern that is determined according to a position of each of the first components.

### (Supplementary Note 7)

The information processing apparatus according to any one of supplementary notes 3 to 6, wherein the determination unit configures each of the divided regions as a congruent shape that includes a plurality of the first components.

### (Supplementary Note 8)

The information processing apparatus according to any one of supplementary notes 1 to 7, further including a plurality of attention mechanism units each configured to have the extraction unit, the determination unit, and the reflection unit.

### (Supplementary Note 9)

The information processing apparatus according to supplementary note 8, further including a plurality of feature extraction units with a predetermined range of kernel and the attention mechanism units.

### (Supplementary Note 10)

An information processing method causing an information processing apparatus to execute:
an extraction step of extracting, from a feature map, a first feature map pertaining to a first feature constituted of a plurality of first components, a second feature map pertaining to a second feature constituted of a plurality of second components, and a third feature map pertaining to a third feature;
a determination step of determining a correspondence relationship indicating a plurality of the second components associated to each of the first components by shifting a grid pattern indicating a plurality of the second components associated to one of the first components on the second feature map, based on a position of each of the first components; and
a reflection step of reflecting a correlation between the first feature and the second feature that are calculated from the correspondence relationship, in the third feature map.

### (Supplementary Note 11)

A program causing an information processing apparatus to execute:
an extraction step of extracting, from a feature map, a first feature map pertaining to a first feature constituted of a plurality of first components, a second feature map pertaining to a second feature constituted of a plurality of second components, and a third feature map pertaining to a third feature;
a determination step of determining a correspondence relationship indicating a plurality of the second components associated to each of the first components by shifting a grid pattern indicating a plurality of the second components associated to one of the first components on the second feature map, based on a position of each of the first components; and
a reflection step of reflecting a correlation between the first feature and the second feature that are calculated from the correspondence relationship, in the third feature map.

Although the disclosure has been described above with reference to the example embodiments, the disclosure is not limited by the above description. The structure and details of the present disclosure can make various changes that may be understood by those skilled in the art within the scope of the present disclosure.

This application is based upon and claims the benefit of priority from Japanese Patent Application No. 2021-041852, filed on Mar. 15, 2021, the disclosure of which is incorporated herein in its entirety by reference.

### REFERENCE SIGNS LIST

10 to 16 INFORMATION PROCESSING APPARATUS
101 PROCESSOR
102 RAM
103 ROM
104 STORAGE DEVICE
105 INPUT DEVICE
106 OUTPUT DEVICE
107 DATA BUS
110 ATTENTION MECHANISM UNIT
111 EXTRACTION UNIT
112 DETERMINATION UNIT
113 REFLECTION UNIT
120 ATTENTION MECHANISM UNIT
121 EXTRACTION UNIT
122 COMPUTATION UNIT
123 AGGREGATION UNIT
124 OUTPUT UNIT
200 CONVOLUTION UNIT
210 PATCH-BASED ATTENTION MECHANISM UNIT

What is claimed is:

1. An information processing apparatus comprising:
at least one memory configured to store instructions; and
at least one processor configured to execute the instructions to:
extract, from a feature map, a first feature map pertaining to a first feature constituted of a plurality of first components, a second feature map pertaining to a second feature constituted of a plurality of second components, and a third feature map pertaining to a third feature;
determine a correspondence relationship indicating a plurality of the second components associated to each of the first components by shifting a grid pattern indicating a plurality of the second components associated to one of the first components on the second feature map, based on a position of each of the first components; and
reflect a correlation between the first feature and the second feature that are calculated from the correspondence relationship, in the third feature map.

2. The information processing apparatus according to claim 1, wherein the at least one processor is further configured to determine the correspondence relationship by shifting the grid pattern on the second feature map, based on a position of each of the first components in such a way that each of the second components is associated to at least one of the first components.

3. The information processing apparatus according to claim 2, wherein the at least one processor is further configured to determine the correspondence relationship by dividing the first feature map into a plurality of divided regions and shifting the grid pattern on the second feature map, based on a position of each of the first components in such a way that each of the second components is associated to at least any one of the first components in each of the divided regions.

4. The information processing apparatus according to claim 3, wherein the at least one processor is further configured to determine the correspondence relationship by shifting the grid pattern on the second feature map, based on a position of each of the first components in such a way that each of the second components is associated to any one of the first components in each of the divided regions.

5. The information processing apparatus according to claim 4, wherein the at least one processor is further configured to determine the correspondence relationship by setting the first components that are associated one-to-one with each other in all the divided regions and shifting the grid pattern on the second feature map, based on a position of each of the first components in such a way that the grid pattern is placed at the same position on the second feature map with the associated first components.

6. The information processing apparatus according to claim 5, wherein the at least one processor is further configured to determine the correspondence relationship by shuffling, with a predetermined probability, a position, on the second feature map, of the grid pattern that is determined according to a position of each of the first components.

7. The information processing apparatus according to claim 3, wherein the at least one processor is further configured to configure each of the divided regions as a congruent shape that includes a plurality of the first components.

8. The information processing apparatus according to claim 1, wherein the at least one processor is further configured to extract the first feature map, the second feature map and the third feature map, determine the correspondence relationship and reflect the correlation multiple times each.

9. The information processing apparatus according to claim 8, wherein the at least one processor is further configured to extract feature with a predetermined range of kernel multiple times.

10. An information processing method causing an information processing apparatus to execute:
extracting, from a feature map, a first feature map pertaining to a first feature constituted of a plurality of first components, a second feature map pertaining to a second feature constituted of a plurality of second components, and a third feature map pertaining to a third feature;
determining a correspondence relationship indicating a plurality of the second components associated to each of the first components by shifting a grid pattern indicating a plurality of the second components associated to one of the first components on the second feature map, based on a position of each of the first components; and
reflecting a correlation between the first feature and the second feature that are calculated from the correspondence relationship, in the third feature map.

11. A non-transitory computer-readable medium having stored therein a program causing an information processing apparatus to execute:
extracting, from a feature map, a first feature map pertaining to a first feature constituted of a plurality of first components, a second feature map pertaining to a second feature constituted of a plurality of second components, and a third feature map pertaining to a third feature;
determining a correspondence relationship indicating a plurality of the second components associated to each of the first components by shifting a grid pattern indicating a plurality of the second components associated to one of the first components on the second feature map, based on a position of each of the first components; and
reflecting a correlation between the first feature and the second feature that are calculated from the correspondence relationship, in the third feature map.
